(19) United States
(12) Patent Application Publication
(10) Pub. No.: US 2007/0138234 A1
(43) Pub. Date: Jun. 21, 2007

(54) Technique for stress redistribution

(76) Inventors: Dave E. Waskey, Bedford, VA (US); Ronald J. Payne, Forest, VA (US); Stephen M. Levesque, Lynchburg, VA (US); Ben R. Grambau, Lynchburg, VA (US); Harold W. Behnke, Lynchburg, VA (US)

Correspondence Address: VYTAS R. MATAS, 2412 CEDARWOOD RD., PEPPER PIKE, OH, 44124, US

(21) Appl. No.: 11/432,926

(22) Filed: May 12, 2006

Related U.S. Application Data
(60) Provisional application No. 60/680,909, filed on May 13, 2005.

(51) Int. Cl. A47J 36/02

(52) U.S. Cl. 228/101

(57) ABSTRACT

A technique for maintaining-designs tolerances and reducing stress during welding of closures on nuclear waste containers.

### BACKGROUND OF THE INVENTION

1) Field of the Invention

This invention relates to a technique for minimizing weld joint variability and reducing stresses in a sealed cask comprising a plurality of welded components. More specifically, this invention relates to a technique for minimizing weld joint variability and reducing residual stresses in welded casks for storing radioactive waste materials.

2) Description of the Prior Art

The level of radioactivity of the material is used to classify nuclear wastes. The classification of radioactive wastes is determined for handling, transportation and disposal purposes. The safe handling, transportation and disposal of spent nuclear fuel and other radioactive high level wastes requires casks, commonly called casks, that must remain leak proof for at least 10,000 years or more. Casks for high-level nuclear waste and spent nuclear fuel must be robust and very secure. High level waste casks are designed and manufactured under design criteria and regulations established by the United States government Department of Energy and international agencies. There are many kinds and sizes of high level waste material casks. Current technology is to construct the casks from metals, usually stainless steel and nickel-based alloys, using welding techniques to obtain strong, long lasting leak proof seams and joints.

The casks are constructed with several primary components, i.e., a cylindrical inner vessel, a cylindrical outer corrosion barrier and inner, intermediate and outer closures. The inner cylindrical vessel is constructed from rolled stainless steel plates that are roll formed to half cylinders and welded together into a cylinder.

The closure for the inner vessel must have an inner closure made from stainless steel type 316 and an outer corrosion barrier must have a closure made from Alloy 22. The closures are made from roll formed plates, cut to the correct diameter and machined in preparation for welding to the vessel and corrosion barrier.

The casks are used for temporary and permanent storage of high level wastes. The casks can have various shapes and sizes but casks commonly are generally cylindrical with cylindrical disk closures and all seams and joints are welded to assure leak proof performance for the design life of the casks.

To help achieve a high level of confidence in the integrity of casks used to store nuclear wastes, the seams and joints of the casks should be welded in a condition where the clearances between mating parts -are minimized and the tensile residual internal stress in all parts of the cask is as low as possible and surface stress is within specification. The cask components are manufactured to close tolerances to obtain good fits between mating parts.

High level nuclear waste generates heat which, when stabilized, results in a high material and cask temperature. The heat generated by the waste causes expansion and distortion of the cask portion. The heat energy of the radioactive waste placed in the casks has the ability to heat the cask to an unknown temperature in the range causing an unknown thermal expansion and distortion of the cask.

The elevated temperature of the open container of the cask expands the dimensions thereof thereby changing the intended fit-up gap between the container and the closure. In process thermal treatment of the cask and closure components of the cask can solve both fit-up gap tolerance issues and possibly impart a compressive residual stress to the closure in the finished cask.

The closures for the cask- have not been subjected to the heat from the waste and are therefore at a temperature, which is different from the cask portion. As a result of the expansion of the cask portion, the closure mates to the cask with a tolerance that is dependent upon the original design tolerances in addition to the temperature of the cask. Welding the casks in this manner requires a process that can accommodate large fit-up tolerances. Among the various welding techniques available, gas tungsten arc welding can tolerate joint mismatches of approximately one-tenth of an inch. On the other hand, high energy density welding processes that use a keyhole mode of welding require smaller fit-up tolerances but are capable of producing a superior weld. Keyhole mode welding can achieve higher productivity rates than conventional arc welding reduce the compressive residual stress in the weld and adjacent base materials. Up to now, large clearances and distortion in nuclear waste cask components have prevented the use of high energy density keyhole welding techniques.

Keyhole welding is a method of welding in which a high energy density beam creates a vapor cavity in the part to be welded, which is then filled in with liquid metal. For example, electron beam welding and laser beam welding require fit-up tolerances of approximately one-hundredth of an inch. The tolerances required to use a keyhole welding process have been considered the reason for not using these technologies for nuclear waste cask welding operation. As a result, gas tungsten arc welding has been chosen as the welding process for the casks.

### SUMMARY OF INVENTION

This invention solves the problems of component expansion and irregular clearances due to differentials in component temperatures, i.e., the fit-up problem associated with the use of keyhole welding processes in the fabrication of nuclear waste casks.

The invention is an in-process thermal treatment of the cask (and other cask components including the closures) during the closure of the cask to achieve and maintain a known reference temperature of the cask, its contents and components that is above the temperature expected from the decay heat of the radioactive waste.

Knowledge of the temperature that the parts will be welded can be used to eliminate the variability of clearances and expansion resulting from disparate component temperatures as mentioned above, but the machining variation would still exist. Therefore, it is beneficial to allow the cask portion to cool and shrink-fit to the closure in the cask. The shrink-fit maintains a constant fit-up for the weld joint around the cask regardless of quality or part variations due to temperature or machining. The shrink fit significantly reduces clearances and allows the use of a keyhole welding process on the cask, which offers the benefit of increased productivity and reduced residual stress (from reduced heat input and reduced weld volume required when using a high energy density keyhole welding process).

Alternatively, this same concept may provide a benefit to the any weld process by using the shrink fit concept to improve the residual stress of the component upon cooling. If the cask and closure are heated (expanded) and the cask is allowed to cool, the cask will shrink to an interference fit with the closure.

The size of the closure and the interference caused by the shrink fit will determine the amount of residual stress redistribution because the shrinkage induced stress will vary with closure size. This process will produce a compressive stress at the weld and heat affected zone, but will most likely produce tensile hoop stresses at the outer surface of the corrosion barrier of the cask. The peak stresses are expected to decrease, thus decreasing the likelihood of stress induced defects such as stress corrosion cracking. Redistributing the tensile residual stresses to a wrought structure at the outer surface of the cask is expected to aid in the prevention of stress corrosion cracking.

Waste packages have been designed for the closure welds to be performed in the flat position with gas tungsten arc welding. The use of high energy density keyhole welding processes (electron beam, laser) while capable of producing superior welds, have not been possible due to the large variation of clearance between the cask and the closure. High energy density keyhole welding processes require tight joint fit-up with precise tolerances.

Welding a cylindrical cask in the flat position results in a high restraint at the weld joint. Heating the closure and other components of the cask to a desired temperature prior to welding offers two possible benefits:
1. Repeatable fit-up tolerance of the weld joint
2. Residual stress redistribution benefits the closure process and possibly extends the life of the cask by reducing the tensile residual stress of the cask and the welds therein.

This invention decreases the variability of joint fit-up tolerances in nuclear waste casks during the final closure welding process.

This invention provides the additional benefit of internal stress redistribution in nuclear waste casks closed by any fusion welding process by using the thermal expansion and contraction of the components to achieve compressive residual stress in the closure weld.

Alternative welding processes could be used to minimize or eliminate the residual stress in the joint.

Friction welding creates a solid-state bond between the materials to be joined. This can be achieved by several means including inertia friction welding, direct-drive friction welding, and friction stir welding. Development of a friction welding machine of this size and magnitude would be very expensive and the casks would require redesign.

Another process that would minimize or eliminate the stresses from the joining process would be brazing or soldering the joint. Brazing would be more applicable in this application due to the residual heat that the waste generates. The most beneficial brazing process would be diffusion brazing, where the brazed joint approaches the melting temperature of the base material. In order to perform a brazing process the cask would need to be placed in an oven or locally heated to a tempera

### BRIEF DESCRIPTION OF THE DRAWING

FIG. 1 is an outline of a cylindrical cask.

FIG. 2 is a partial sectional view through the cask taken along the line 2-2 of FIG. 1.

### DESCRIPTION OF THE PREFERRED EMBODIMENT

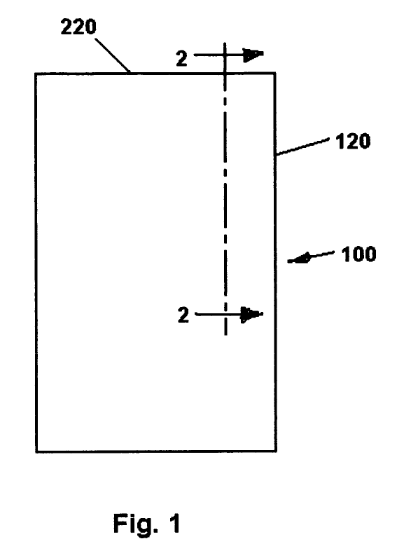

FIG. 1 is an outline drawing representing a cylindrical nuclear waste cask 100. In FIG. 1, the cask 100 comprises a cylindrical outer corrosion barrier 120 and a flat closure 220.

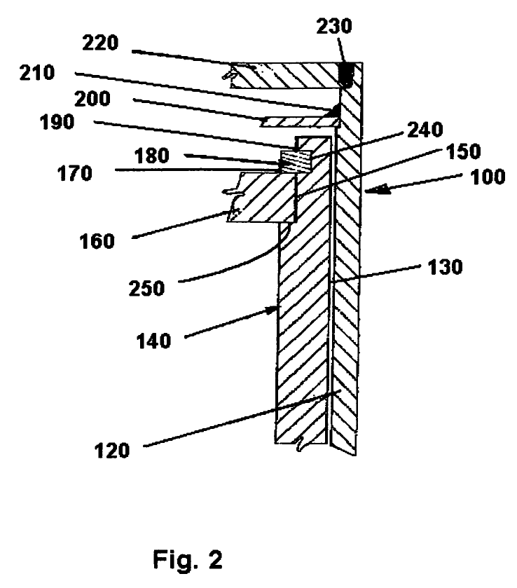

FIG. 2 is a partial sectional view through a wall of the cask 100 taken along the section line 2-2 in FIG. 1. Referring to FIG. 2, the cask 100 comprises the outer corrosion barrier 120, an inner vessel 140 separated from the corrosion barrier 120 by space 130. The inner vessel 140 has a first radial shoulder 250, a radial face 240, axially extending surface 150, and an inwardly facing C-shaped groove 240. The principles of this invention are applicable to any weldable materials. However, the United States Department of Energy requirements for the design and construction certain nuclear waste cask call for a Nickel alloy outer corrosion barrier made from Alloy 22 (60% nickel, 22% chromium, 13% molybdenum, and 3% tungsten) and an inner vessel made from stainless steel (316NG) with additional limitations on carbon and nitrogen.

The cask 100 is designed to contain high-level nuclear waste that will heat the cask 100 through energy released in the process of radioactive decay. The temperature of the cask 100 varies on the radioactivity of the waste in the cask 100 and the amount of time that the cask 100 has held waste.

Prior to closure and sealing of the cask 100, the cask 100 is open and the closure components inner closure disk 160, locking ring 180, intermediate closure disk 200 and outer closure disk 220 are not subject to the heat generated by the nuclear waste. The temperature differential between the cask 100 and closure components 160, 180, 200 and 220 leads to variation of the dimensions of the cask corrosion barrier 120 and inner vessel 140 and the closure components 160, 180, 200 and 220 from the design intent. The temperature differential also changes the tolerances between the inner vessel 140 and corrosion barrier 120 and the closure components 160, 180, 200 and 220 due to thermal expansion of the metal alloy from which the cask 100 is made. In addition to thermal expansion, machining variability on a large cask is difficult to control.

The materials used in nuclear waste casks and the procedure relating to final closure thereof is defined by U.S. Department of Energy regulations. The inner vessel 140 is to be closed by placing a disk-shaped stainless steel inner closure disk 160 on a radial face 250 on inner vessel 140, engaging a C-shaped locking spread ring 180 with the radial face 250 and axially extending face 150, and placing seal welds 170 and 190 on the spread ring 180 to ensure leak tightness of the inner closure disk 160. The seal welds 170 and 190 are to be performed in accordance with the welding requirements qualified to Section IX of the ASME Code. The stainless steel closure disk 160 is held in place by the locking spread ring 180, and the seal weld 170 is not a structural weld. The seal welds 170 and 190 must not permit any leakage from the inner vessel 140.

The middle Alloy 22 (UNSNO6022) closure 200 is to be closed with a sealing weld 210 that is intended to function as part of the corrosion barrier 120 and is not a structural weld.

The outer Alloy 22 closure 220 is to be closed with a full thickness narrow groove or keyhole weld 230. The weld 230 is a structural weld.

The process of the present invention requires that the cask 100 and all closure components inner closure disk 160, locking spread ring 180, intermediate closure disk 200 and outer closure disk 220 be located in a chamber or room where they can be heated to a temperature above the temperature of the cask 100.

After the cask 100 and components 160, 180, 200 and 220 are heated and stabilized at a uniform temperature. At that temperature, the inner closure disk 160 is placed on the radial shoulder 250 of inner vessel 140, the locking ring 180 is placed in the C-shaped groove 240 defined by the inner vessel 140. Welds 170 and 190 are added to the inner circumference of the lock ring 180 and intersection of the lock ring 180 and inner vessel 140 to seal the contents of the inner vessel 140. The intermediate closure disk 200 is then located and welded to the corrosion barrier 130 to create a leak proof seal therebetween.

The outer closure disk 220 is placed in the corrosion barrier 130 and welded in place using an appropriate welding technique.

In a variation on the method of the present invention, the corrosion barrier 130 maybe cooled to create a shrink fit interference between the closure disc 220 and corrosion barrier 130. The shrink fit reduces clearances and distortions between the corrosion barrier 130 and closure disk 220. The reduced clearances and distortion allows the use of high energy density welding techniques such as electron beam and laser beam welding. Other welding techniques such as gas tungsten arc welding can also be used.

1. A method of achieving design clearances and reducing residual stress during welding of a closure to a cylindrical cask containing nuclear waste comprising:
heating the cask and to a uniform temperature above the maximum temperature from decay heat of the cask contents (radioactive materials);
welding the closure part to the casks using a high energy density keyhole welding process, which increases production rate and decreases heat input; and
allowing the cask to cool to its ambient temperature.

2. A method of achieving design clearances and reducing residual stress during welding of a closure to a cylindrical cask containing nuclear waste comprising:
heating the cask to a uniform temperature above the maximum temperature from decay heat of the cask contents (radioactive materials);
placing a closure disk in the cask,
cooling the cask to create a interference fit between the cask and the closure disk, and
welding the closure part to the cask.
